(19) United States
(12) Patent Application Publication
(10) Pub. No.: US 2025/0215942 A1
(43) Pub. Date: Jul. 3, 2025

(54) LINEAR ACTUATING DEVICE OF A BRAKE CALIPER AND BRAKE CALIPER WITH SAID DEVICE

(71) Applicant: BREMBO S.p.A., Curno (Bergamo) (IT)

(72) Inventors: Andrea CASADIO, Curno (Bergamo) (IT); Cristiano FISSORE, Curno (Bergamo) (IT)

(73) Assignee: BREMBO S.p.A., Curno (Bergamo) (IT)

(21) Appl. No.: 18/848,946

(22) PCT Filed: Mar. 21, 2023
(86) PCT No.: PCT/IB2023/052755

§ 371 Date: Sep. 20, 2024

(30) Foreign Application Priority Data
Mar. 21, 2022 (IT) 102022000005498
Mar. 21, 2022 (IT) 102022000005501
Mar. 21, 2022 (IT) 102022000005504
Mar. 21, 2022 (IT) 102022000005507

(51) Int. Cl. F16D 65/00; F16D 65/18; F16D 121/24; F16D 125/40; F16D 125/50

(52) U.S. Cl. CPC F16D 65/0068; F16D 65/183; F16D 2121/24; F16D 2125/40; F16D 2125/50

(57) ABSTRACT

A linear actuating device for a brake caliper adapted to bias at least one brake pad to abut against a braking surface of a brake disc is provided. The linear actuating device has a motor having a rotating drive shaft and a stator, a rotational wave generator of a strain wave gearing of a harmonic transmission, the rotational wave generator being made in one piece with the rotating drive shaft, and a harmonic reducer, the harmonic reducer being elastically deformed and rotated by the rotational wave generator. A rotary-to-linear motion conversion device, adapted to transform a rotary motion into a linear motion adapted to bias the at least one brake pad to abut against the braking surface along an axial direction, is rotatably connected to the harmonic reducer.

### FIELD OF THE INVENTION

The present invention relates to the technical field of actuating devices of a brake caliper of a disc brake adapted to slow down or park a vehicle. The present invention also relates to brake calipers comprising at least one actuating device of a brake caliper. The present invention also relates to a disc brake comprising a brake caliper comprising at least one actuating device of a brake caliper.

In particular, the present invention relates to the technical field of braking devices of the electromechanical type.

### BACKGROUND ART

In a disc brake, the brake caliper is generally arranged straddling the outer peripheral margin of a brake disc, adapted to rotate about a rotation axis (A-A) defining an axial direction (X-X). In a disc brake, a radial direction (R-R), substantially orthogonal to said axial direction (X-X), and a tangential (C-C) or circumferential (C-C) direction, orthogonal to both said axial direction (X-X) and said radial direction (R-R), are further defined.

Brake calipers are constrained to a support structure, which remains stationary with respect to the vehicle wheel, such as a stub axle of a vehicle suspension or a vehicle wheel hub or a fork. The brake caliper usually comprises a caliper body having two elongated portions arranged so as to face opposite braking surfaces of a brake disc, and at least one bridge connecting said two elongated portions to each other. Conveniently actuated calipers press the pads against the braking band and the braking action is produced by the friction between the pads and the braking band of the brake disc.

Current brake systems, especially the electro-actuated ones, suffer from the drawback of having a high complexity of construction and layout, given the need to have an electromechanical actuation system applied to the braking system. Said complexity is also apparent from the number of components involved and thus their integration within a brake caliper.

In particular, the need is strongly felt to make the electro-actuation function of the brake caliper modular by simplifying the transmission and torque multiplier function, and maximize the integration of the components involved in the generation of the braking pressure to generate a single sub-assembly compatible with various braking systems.

The integrated technological use included in the context of the functions required of an electromechanical actuation of a braking system enhances the purposes of the invention by leveraging some peculiarities which are lacking to date on the solutions currently used on the market and opening up new development scenarios for the field of electro-actuated braking systems. . . .

In the prior art, several solutions can be found for the transmissions (reducers) of electro-actuated calipers. For example:
gear cascade transmissions;
transmissions with epicyclic gears;
mixed transmissions with gear cascades and epicyclic gears.

For example, such solutions are known from U.S. Pat. Nos. 10,421,445B2, 6,367,593B1, 6,412,610B1, WO2020101444A1, EP1321691B1.

Document US2020156612A1 to Toyota Motor CO LTD describes an actuator of a brake caliper. This actuator includes a housing; an electric motor with a rotating hollow drive shaft; a rotating shaft arranged inside the drive shaft and coaxial with the drive shaft; a piston with a rear end arranged inside the drive shaft and a front end engaged with the brake pad; a speed reduction mechanism which decelerates the rotation transmitted by the drive shaft and transmits the rotation to the rotating shaft; and a motion conversion mechanism which converts a rotary motion of the rotating shaft into an advancing/retracting motion of the piston. The drive shaft is rotatably supported by the housing at an outer peripheral surface thereof, and the rotating shaft is rotatably supported by an inner peripheral surface of the drive shaft by means of roller bearings at an outer peripheral surface thereof as well as with the housing by means of a thrust bearing at the rear end of the rotating shaft.

Document CN1836116A to PBR Australia PTY LTD describes an actuator comprising an electric motor in which the rotor defines a bearing surface having a non-circular profile, and a radially flexible annular sleeve (24) defines a facing bearing surface. The flexible sleeve assumes a non-circular shape complementary to the profile of the resting surface. The flexible sleeve is constrained against rotation and is meshingly engaged by means of teeth with a circular transmission ring in at least two contact zones which are mutually equidistant. The transmission ring is rotationally engaged with a screw and threaded sleeve assembly so that the rotation of the transmission ring actuates the screw assembly and causes an exit portion of the screw to extend or retract. The actuator is actuatable so that the rotation of the rotor causes the radial bending of the flexible sleeve in each of the contact regions to generate a rolling wave which causes the rotation of the contact regions and the transmission ring, and the transmission ring rotates at a low rotational speed as compared to the rotational speed of the rotor.

Document EP3434925A1 shows a brake caliper comprising a main body unit, a braking unit, and an actuating unit. The main body unit comprises interconnected first and second side seats. The braking unit comprises a first and a second set of pushing arms mounted on the first and second side seats, respectively. The actuating unit moves at least part of the first pushing arm assembly. The first pushing arm assembly includes a self-aligning module comprising at least one self-aligning joint, so that misalignment between the first side seat and a portion of the first push arm assembly, without interference between the first push arm assembly and the first side seat is permitted.

Document CN204592094U to Jilin University shows an actuator of an electro-actuated mechanical brake of a vehicle, including the housing body of the motor with a harmonic speed reducer. The power from the motor passes through the drive shaft and the harmonic speed reducer, and the teeth of the flexible gear of a toothed wheel connect to a recirculating ball screw coupled to a screw nut to feed a friction pad against a brake disc. The motor is screwed to the reducer, which in turn is screwed to the support of the screw nut which keeps the screw axially constrained.

However, these known solutions have the following problems:
high axial volume and the consequent difficulty of installation on vehicles;
high radial volume and consequent difficulty of integration with the caliper body and overall housing in the wheel well;
high number of components;
product assembly complexity (electromechanical caliper);
product design complexity;
high mechanical clearance in the mechanical transmission (gear trains and epicyclic gears resulting in increased reduction of response times of the brake caliper and the braking system);
need to use additional actuated auxiliary electromechanical units to fulfill the stationary function;
uncontrolled reversibility in case of failure.

One suggested solution to compact the electromechanical actuating devices is given by the use of the harmonic gear (strain wave) technology, also known under the Harmonic Drive™ brand name.

For example, from document U.S. Pat. No. 6,664,711B2 it is known to make a harmonic transmission in which the motor inside the transmission magnetically energizes an intermediate flexible ring which deforms creating a rotating ellipse capable of meshing on an outer ring having a higher toothing than said flexible ring. This known solution, although very compact, is very complex to manage from both a construction and control point of view, as well as limited power due to the small size of the motor and difficult cooling.

From document EP1877677B1 the application of a solution similar to that described in U.S. Pat. No. 6,664,711B2 is known for creating a rotary motion of a worm screw keyed into a screw nut which is used as a pushing means for pads in a brake caliper. Therefore, all the drawbacks seen in the U.S. Pat. No. 6,664,711B2 solution are also found in the applied solution of EP1877677B1.

An electro-actuated caliper solution is known from document CN104806669A, in which a motor joins and moves a harmonic transmission which rotates a worm screw which advances a screw nut as an abutting piston of a brake pad against a brake disc.

This known solution, although simplified in transmission, is apparently very cumbersome due to the use of components arranged mutually in series.

An electro-actuated caliper solution is known from document US2009057074A1, in which a motor joins and moves a harmonic transmission which rotates a plate which, with cams, translates a facing plate, interposing balls to reduce friction (also known as a ball-in-ramp transmission).

Therefore, this known solution does not reduce the construction complexity compared to the CN104806669A solution and strongly maintains the need to integrate components for reducing the complexity and volume thereof, while maintaining adequate motion reduction and efficiency.

### Solution

It is the object of the present invention to provide a linear actuating device capable of solving the drawbacks of the prior art and in particular having reduced complexity and limited volume.

This and other objects and advantages are achieved by a device according to claim 1, as well as a brake caliper according to claim 17, as well as a disc brake according to claim 18.

Some advantageous embodiments are the subject of the dependent claims.

An analysis of this solution has shown that the suggested solution allows obtaining a solution with much more performance than the solutions of the prior art.

Specifically, the advantages provided by the invention can be summarized as follows:
weight reduction, a particularly important factor especially for a brake caliper which is an unsprung mass;
reduction in the number of components;
reduction in the volume dimensions;
simplification of product layout;
simplification of the integration between the device and the brake caliper body, allowing a modular design, in particular allowing to avoid the need to redesign the caliper and transmission assembly for each new application;
by virtue of the possibility of having a high reduction ratio, having the ability to fulfill the parking brake function without integrating actuated auxiliary electromechanical units, as mentioned under given transmission design conditions;
by virtue of the simplification and the provision of an integrated harmonic transmission, a reduction in brake caliper response times is achieved;
an increase in mechanical reliability by decreasing the number of components;
an increase in transmission member quietness;
achieving controlled reversibility in case of electrical failure under given transmission design conditions;
simplification of industrialization and monitoring of security features.

By virtue of the solutions described below, the following subunits are provided in the solutions, for example:
BLDC (Brushless Direct Current) motor;
Wave generator obtained with a rolling bearing, e.g., a ball bearing;
Flex spline obtained with a deformable cup component;
a fixed ring gear obtained with a static ring;
a rotary-to-linear motion conversion device, which allows the transformation of torque into force (e.g., a recirculating screw or ball-in-ramp device);
the provision of axial and radial bearings to discharge the actions on the cover housing and allow the rotation without translation of some members;
pushing devices (screw or plate) and non-axial force decoupling joints for controlling a pushing plate resting on at least one pad;
anti-rotation devices;
seals;
a force sensor.

One of the innovative components lies in the high integration of a Strain Wave Gear type transmission (also known under the name Harmonic Drive®) with a rotary-to-linear motion conversion device.

For example, the drive shaft made as a hollow steel cylinder allows a series of permanent magnets to be housed while obtaining a non-circular track capable of having the Wave Generator that allows the generation of Strain Wave Gear type transmission waves.

The use of the hollow rotary shaft motor allows integrating therein devices for transforming rotary motion to linear motion (when in a contracted condition with a new, non-worn brake pad), e.g., a recirculating ball screw or a facing-plate device referred to as ball-in-ramp, as well as axial and radial bearings.

The flexible cup or bell, e.g., made of harmonic steel (also referred to as a flex spline), is deformed by the push of the balls rolling on the elliptical track of the wave generator (built into the rotor), which transmits the torque to a motion conversion device (e.g., the recirculating ball or ball-in-ramp screw) due to a forced coupling.

Compared with the use mode of the prior art, providing the torque to the screw nut 41 the recirculating of screw allows positioning the device required for the wear recovery away from the pad. This part of the system will thus be housed inside the hollow drive shaft, optimizing the space utilization and compacting the solution.

For example, the use of the ball-in-ramp allows making a system with a motion conversion feature even of the non-linear type, as a function of the shape of the ramps or tracks or cams creating the lift of the rolling elements.

For example, the force generated by the device acts on the pads by means of the pushing plate, which is uncoupled from the pushing device (screw or plate of the ball-in-ramp) by means of a joint and a shoe, to avoid the forces other than merely axial ones from being transmitted to the mechanism.

For example, all components are made of steel (harmonic, quenched and tempered, and plastic deformation steel), except for:
the cage of the wave generator bearing, made of aluminum or brass;
the permanent magnets of the rotor, made of plastoneodymium;
the overmolding of the magnets, made of plastic;
the cage of the axial thrust bearing, made of aluminum or brass;
the rubber of the seals.

The present invention allows making an electromechanical caliper with a small number of components (about −50% in the present embodiment), with the following advantages:
simple integration of the device in the caliper body, for example by screwing the cover housing to the edge of the seat provided in the caliper body, system assembly and installation on the vehicle (screwing the module itself, or possibly welding or the like);
higher mechanical reliability, calculated as the product of the reliabilities of the chain of components forming the device;
modularity of installation with the use of the same actuation (device) on different calipers per application/customer and car side (right/left).

The advantages offered by this system ensuring the conversion of motor torque to linear force when applied to the braking means are mainly apparent in:

### Weight Reduction

The compactness of the solution due to a high integration of the components involved to obtain the function of a traditional transmission allows reducing weight component due to the transmission, with the opportunity to reduce the suspended mass component, required by major vehicle manufacturers.

### Component Reduction

The integration of rotor, hollow drive shaft and transmission allows the reduction of almost ⅔ of the components involved in an electromechanical transmission applied to Brake by Wire braking systems; this simplification results in the opportunity to decrease the volume dimensions with the same function in addition to the increase in the mechanical reliability caused by the decrease in the involved components.

### Layout Simplification

The suggested architecture develops the load path perpendicularly to the pressure area that the system should generate to apply the braking torque to the vehicle. The smaller number of components involved provides an opportunity to decrease the load path and therefore the decrease in exogenous causes of inefficiency.

### Simplified Integration on Foundation Brake (Caliper Body)

The solution allows evaluating the development irrespective of the external design of the brake caliper; this offers the opportunity to generate a modular design, in which the foundation brake requires only the development of the mechanical interface of the actuator “module,” allowing more freedom for aesthetic and performance development.

Furthermore, the opportunity obtainable from a “modular” architecture such as that suggested for an electromechanical brake caliper arises from the greater industrial production flexibility that the suggested solution possesses per se. It thus results in simplifications or low-impact changes for:
creation of caliper blanks;
mechanical works;
caliper assembly;
aesthetic treatments;
actuation module integration;
functional controls.

### Reductions in Response Times

The smaller amount of components and the simplified layout allow having a greater design management of clearances (required for assemblability), allowing for an increased capacity to manage the electro-actuated mechanics, and the consequent dilution of actuation times.

### Quietness

The suggested simplification, aiming at a decrease in the dynamic members involved in the motion conversion, allows decreasing the creep and bump dynamics, the primary cause of noise in mechanical transmissions.

Furthermore, the suggested solution, with a special design of the transmission reduction, allows the integration of the parking brake function without additional members.

The feature of the harmonic reducer or harmonic transmission concerns the poor reversibility of the system, which below a given torque value at the reducer output (back driving torque), does not allow the spontaneous retraction of the reducer. This results in a mechanical locking system being usable by the caliper to perform the vehicle parking function. This allows for the opportunity to avoid the integration of another mechanical/mechatronic locking device by taking advantage of the functions of the actuation motor to manage the parking torque and corrections thereof. This implies that the solution may come in two configurations depending on the desired sizing:
inherent parking brake function in the transmission features;
non-inherent parking brake function in the solution, but to be integrated with additional devices/members.

### Simplification in Industrialization and Monitoring of Safety Features

Reducing the number of components required for assembly and the number of machining operations and modifications to be made to the caliper to achieve the braking function, allows reducing the controls and critical features to be monitored, thus enabling a simplified component management. This acts on the occurrence of production waste and production issues.

Critical features include the reducer retraction torque, which can be utilized to dispense with an additional parking brake device.

However, by taking advantage of the high gear ratio that a Strain Wave Gear type reducer can provide, it is possible to increase the pitch of the tracks of the rotary-to-linear motion transformation device (helix angle or outline of the cams of the ball-in-ramp) so as to promote reversibility at the expense of higher torque required at the transmission output.

Therefore, the sizing of the present invention can be performed in two ways:
1) Reversible system only by supplying torque to the reducer through additional devices;
2) Spontaneously reversible system under the bias of the elastic force stored on the caliper with each application.

In type 2 sizing, the helix of the torque-to-force conversion device (recirculating or ball-in-ramp screw) must be chosen so that the typical retraction torque of the reducer will always be less than the unscrewing torque of the torque-to-force conversion device at the given force value specified by the system requirements and the chosen safety concept.

### DRAWINGS

Further features and advantages of the device, the disc brake, and the method will become apparent from the following description of preferred embodiments thereof, given by way of non-limiting indication, with reference to the accompanying drawings, in which:

FIG. 1 shows a wheel-side axonometric view of a disc brake according to the invention;

FIG. 2 shows a radial view, facing the rotation axis of the brake disc, of the disc brake in FIG. 1 without the brake disc;

FIG. 3 shows an axial view, facing the vehicle wheel, of the disc brake in FIG. 1;

FIG. 4 shows a section view, on an axial radial plane passing through the rotation axis of the linear actuating device, the disc brake in FIG. 1, without the brake disc;

FIG. 5 shows an axonometric view with parts separated of the brake caliper of the disc brake in FIG. 1 looking towards the vehicle and without the brake disc;

FIG. 6 shows an axonometric view with parts separated of the brake caliper of the disc brake in FIG. 1 looking towards the wheel and without the brake disc;

FIG. 7 shows a section view, on an axial radial plane passing through the rotation axis of the linear actuating device, of the linear actuating device only associated with a pushing plate and dust seal and in a retracted position;

FIG. 8 shows a section view, on an axial radial plane passing through the rotation axis of the linear actuating device, of the linear actuating device only associated with a pushing plate and dust seal and in an extended position;

FIG. 9 shows a local section view, on a radial circumferential plane, of the harmonic transmission of the linear actuating device;

FIG. 10 shows a section view, on an axial radial plane passing through the rotation axis, of the linear actuating device according to a variant in which the rotary-to-linear motion conversion device is of the ball-in-ramp type;

FIG. 11 shows an axonometric view of the pushing side or pushing-plate side of a linear actuating device according to a variant;

FIG. 12 shows an axonometric view of the linear actuating device in FIG. 11 with parts separated;

FIG. 13 shows a section view, on an axial radial plane passing through the rotation axis, of the linear actuating device according to a variant in which the cover housing self-supportingly supports all components of the linear actuating device by forming a cartridge which can be removably applied to a caliper body;

FIG. 14 shows an axonometric section view, on an axial radial plane passing through the rotation axis of the linear actuating device, of the linear actuating device in FIG. 13;

FIGS. 15 to 19 show axonometric or orthogonal views of a brake caliper in which a linear actuating device according to the invention is provided;

FIGS. 20 and 21 show axonometric views of the brake caliper in FIGS. 15-19 with parts separated.

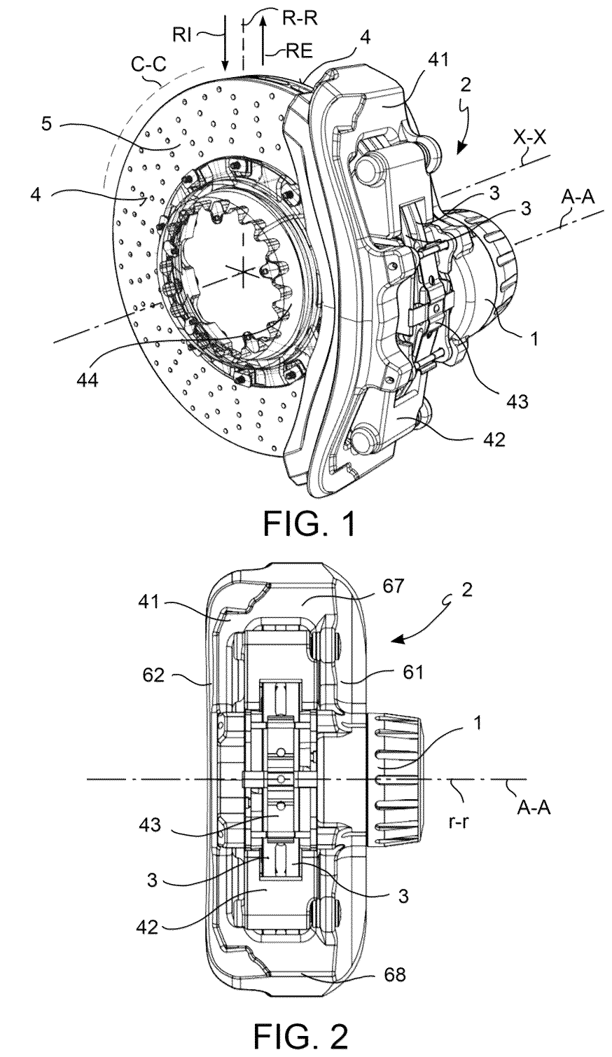

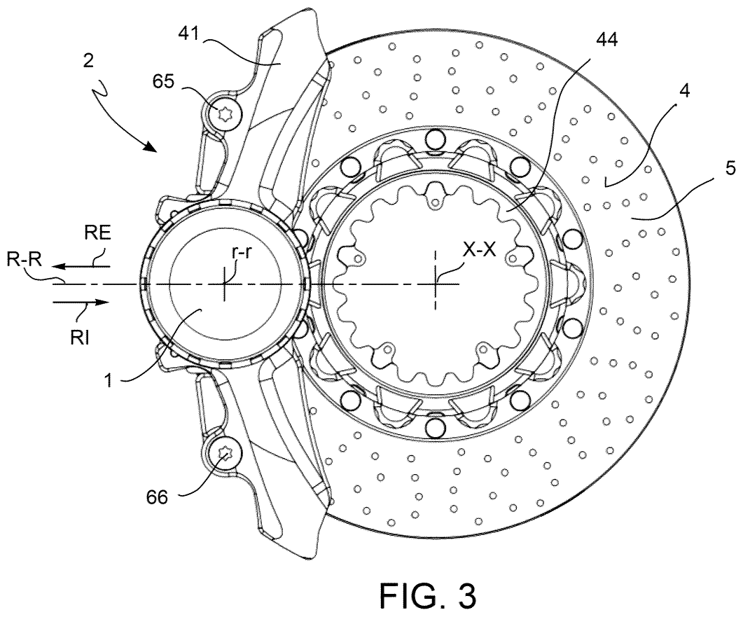

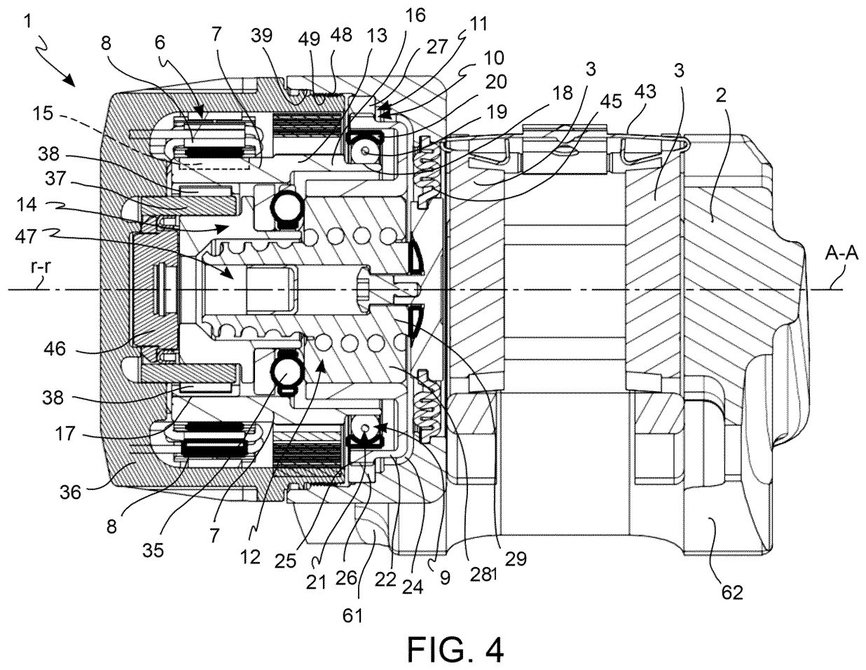

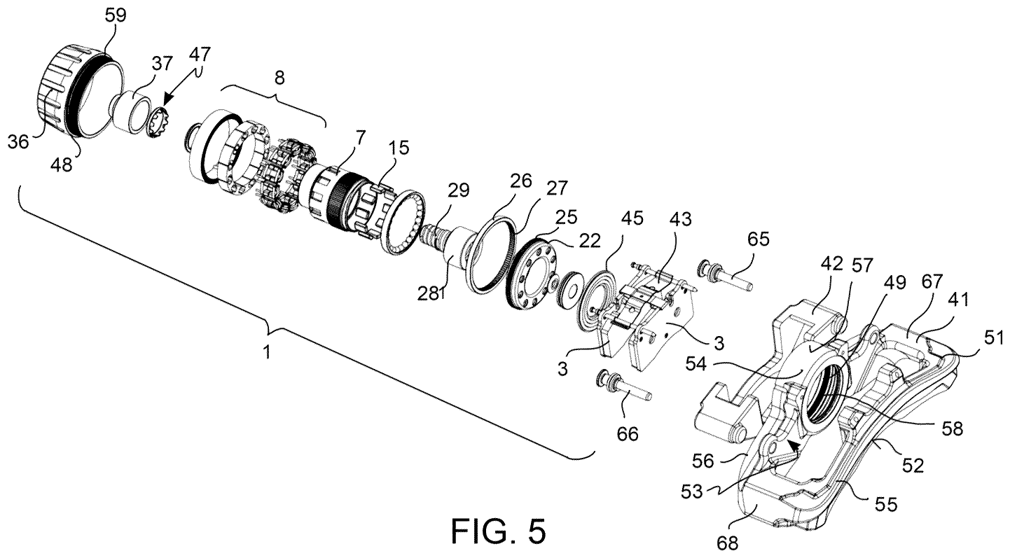

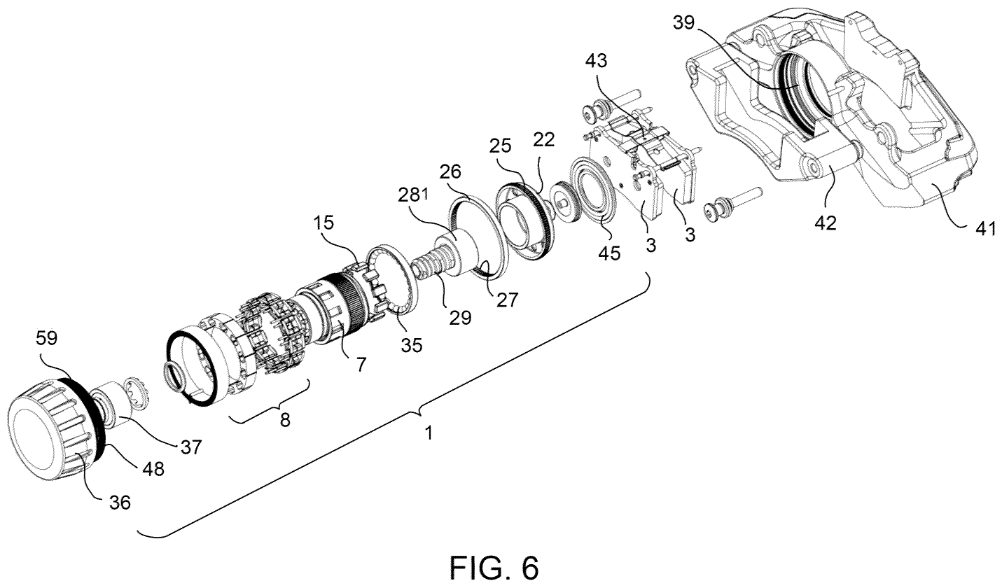

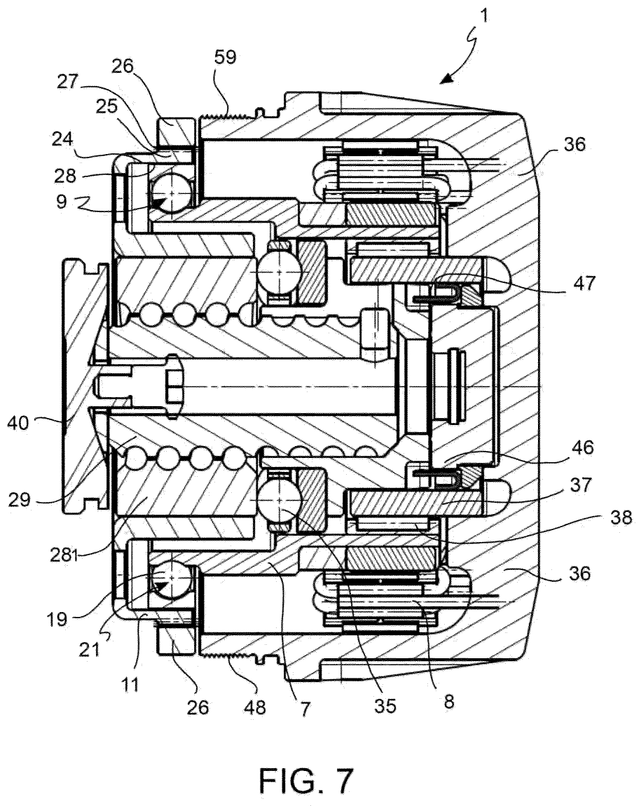

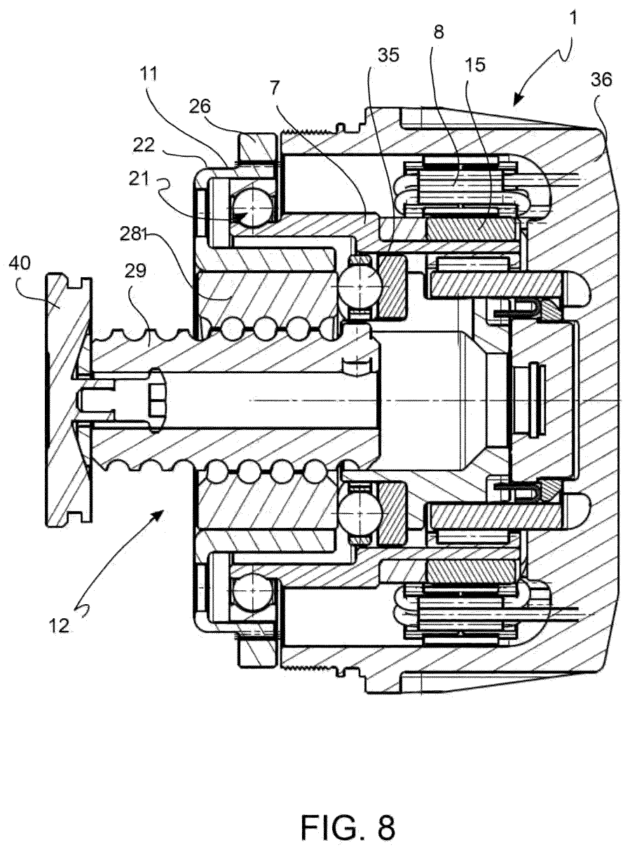

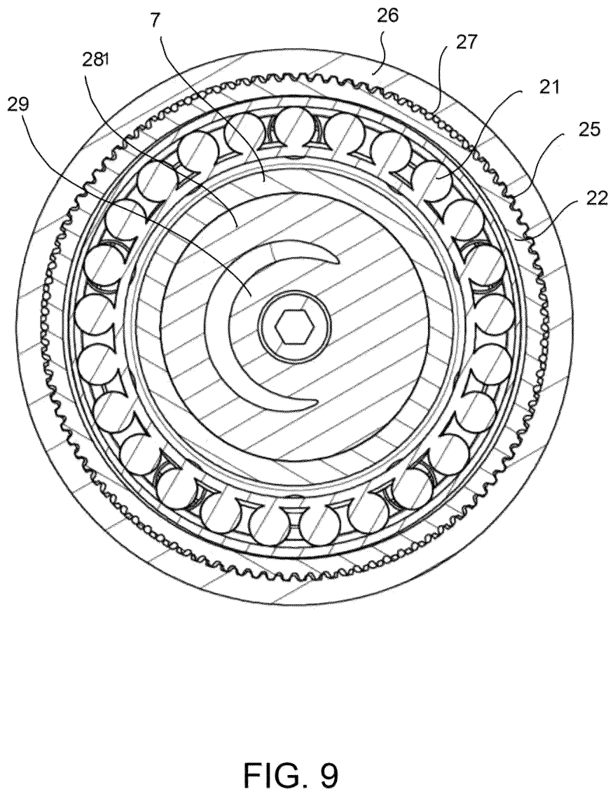

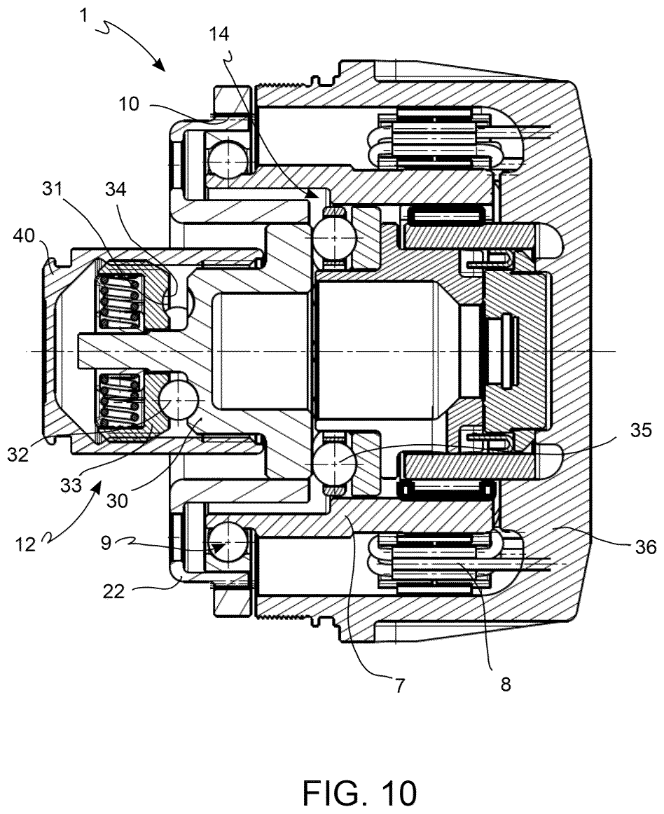

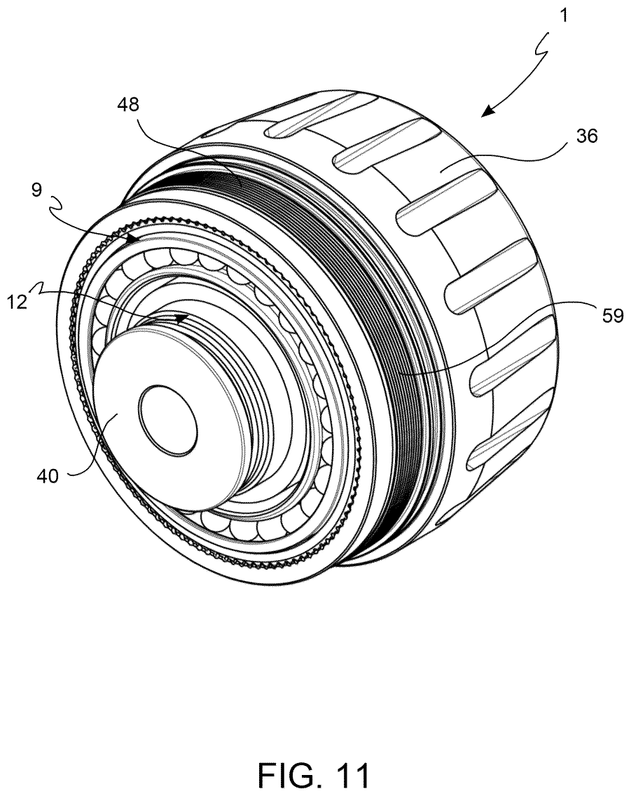

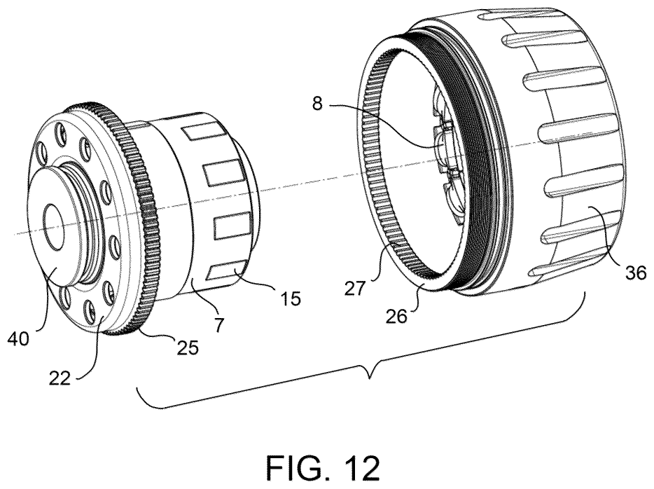

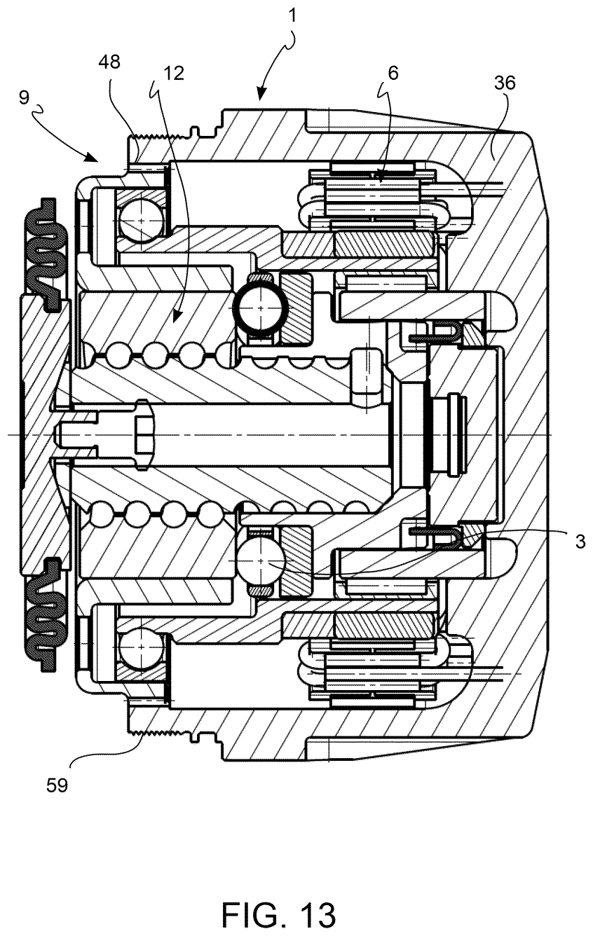

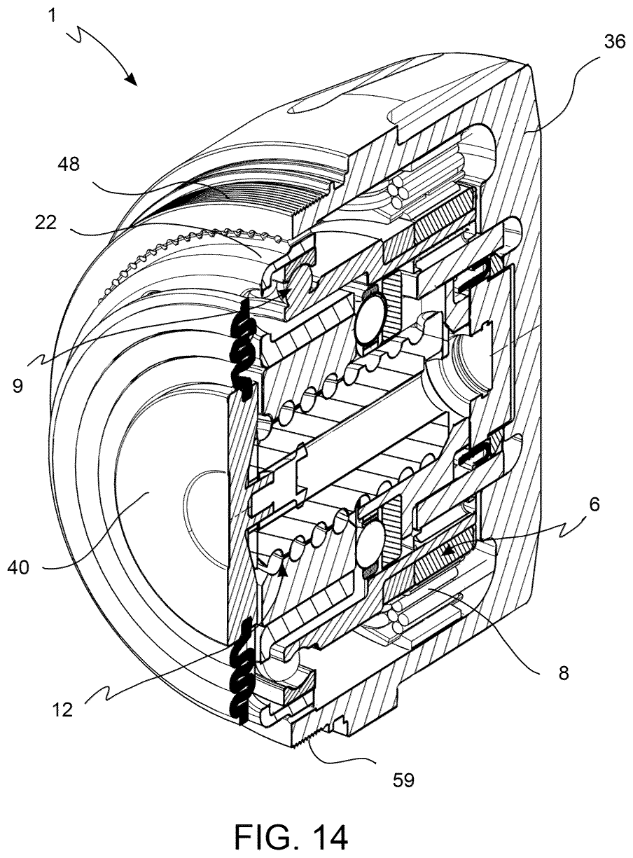

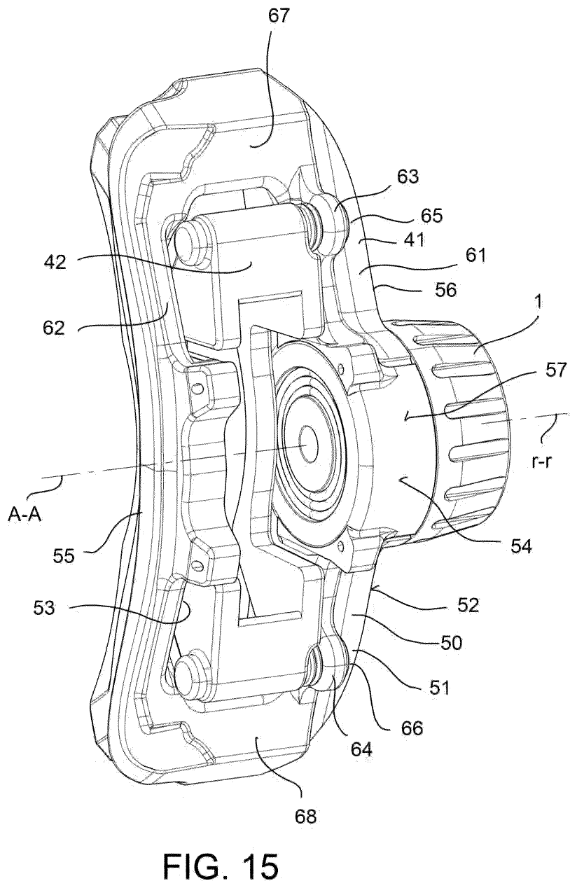

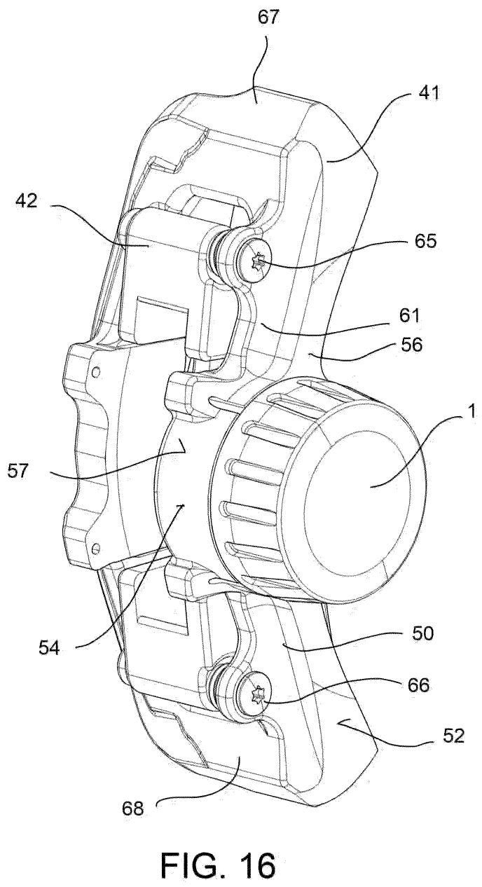

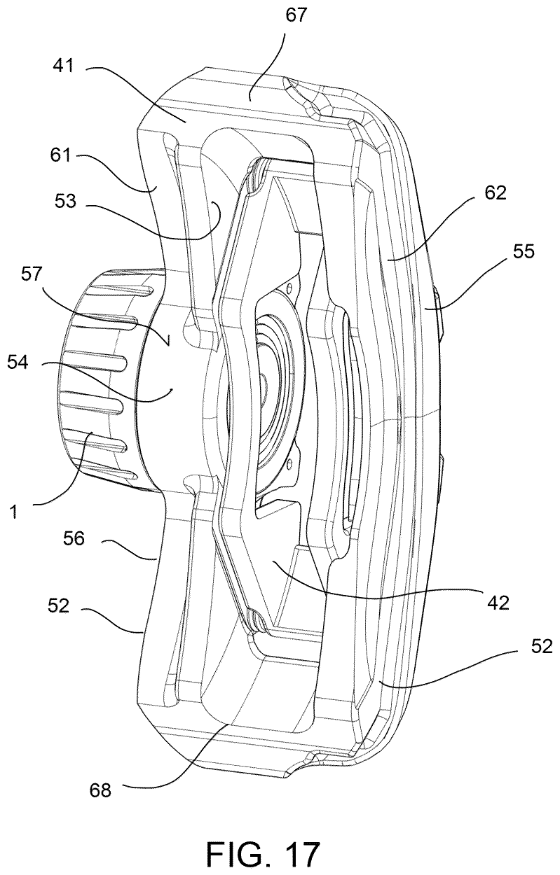

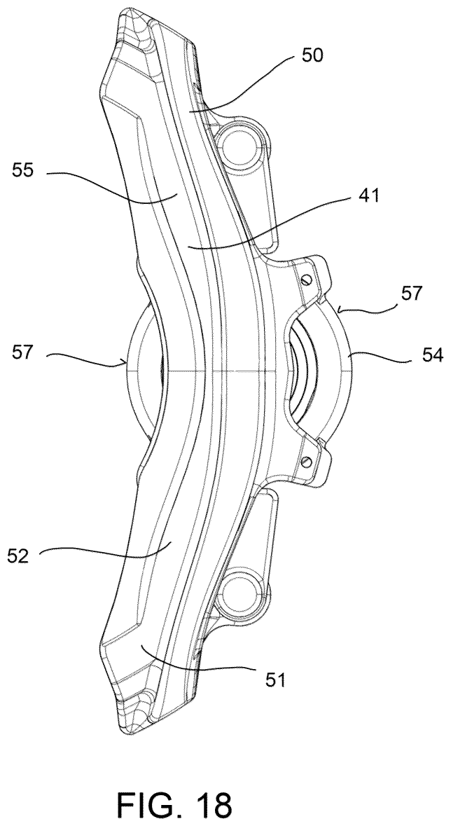

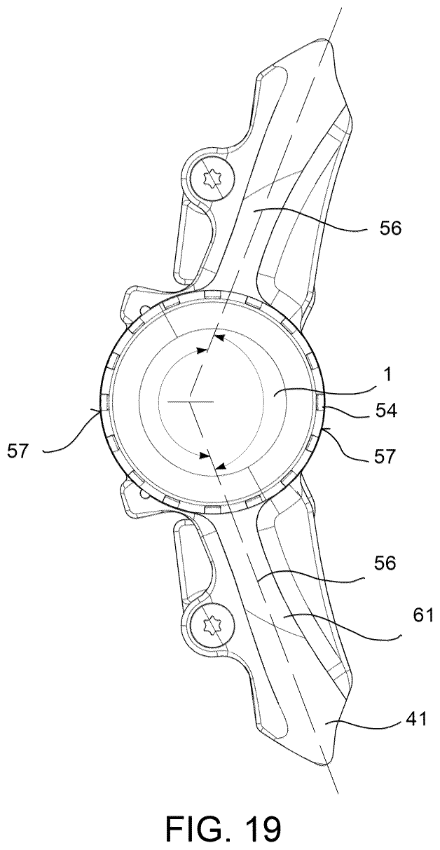

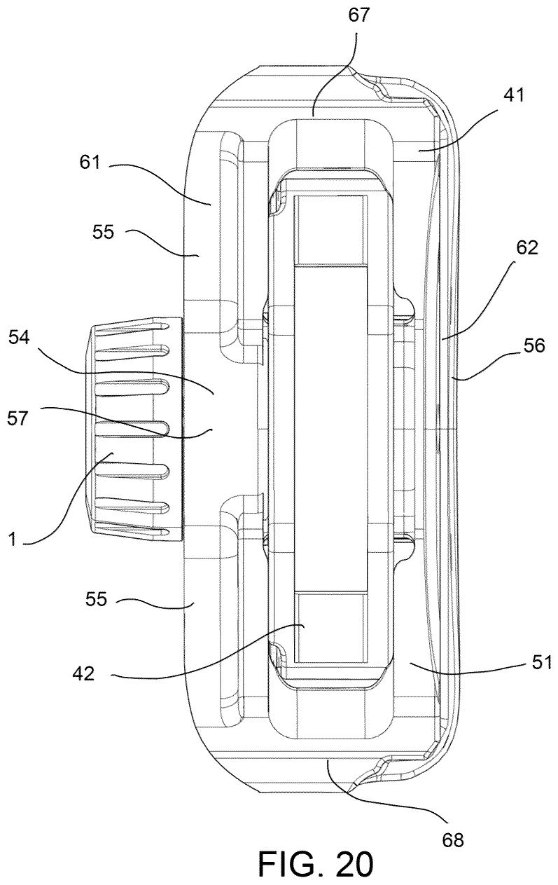

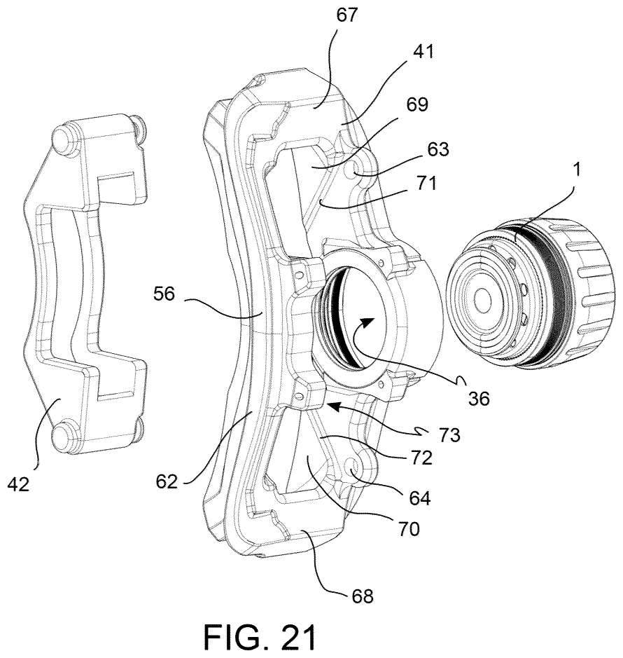

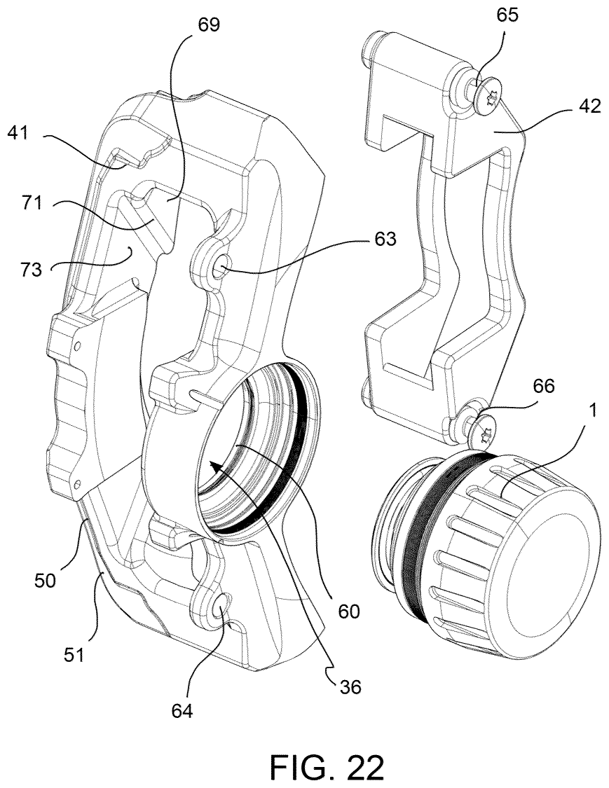

### DESCRIPTION OF SOME PREFERRED EMBODIMENTS

Hereafter, when reference is made to the term “radial” or “radial direction,” as well as “axial” or “axial direction,” as well as “circumferential” or “circumferential direction,” unless otherwise specifically defined, reference will be made to the directions previously defined with reference to the brake disc and the axisymmetric shape thereof, using the same directions also for the brake caliper or the brake caliper body or the actuating device, as if these are mounted and placed to be associated with the brake disc.

According to a general embodiment, a linear actuating device 1 for a brake caliper 2 adapted to bias at least one brake pad 3 to abut against a braking surface 4 of a brake disc 5 is described below.

Said device comprises a motor 6. Said motor 6 comprises a rotating drive shaft 7 and a stator 8.

Said device further comprises a rotational wave generator 9, referred to as a wave generator, which interacts with a strain wave gearing of a harmonic transmission 10, referred to as a strain wave gearing.

Said rotational wave generator 9 is made in one piece with said rotating drive shaft 7.

Said harmonic transmission 10 comprises a harmonic reducer 11. Said harmonic reducer 11 is elastically deformed and rotated by said rotational wave generator 9.

Said device further comprises a rotary-to-linear motion conversion device 12 adapted to transform a rotary motion into a linear motion adapted to bias said at least one brake pad 3 to abut against said braking surface 4 along an axial direction A-A.

Said rotary-to-linear motion conversion device 12 is rotatably connected to said harmonic reducer 11.

According to an embodiment, said drive shaft 7 has a tubular body 13 forming an inner drive shaft chamber 14.

Said rotary-to-linear motion conversion device 12 is accommodated at least partially inside said inner drive shaft chamber 14.

According to an embodiment, said harmonic transmission 10 is superimposed on said rotary-to-linear motion conversion device 12.

According to an embodiment, said rotary-to-linear motion conversion device 12 comprises a screw nut 281 which meshes with a worm screw 29 which translates along an axial direction A-A upon the rotation of the screw nut 281. Said harmonic transmission 10 is superimposed on said screw nut 281.

According to a general embodiment, a linear actuating device 1 for a brake caliper 2 adapted to bias at least one brake pad 3 to abut against a braking surface 4 of a brake disc 5 is described below.

Said device 1 comprises a motor 6. Said motor 6 comprises a rotating drive shaft 7 and a stator 8.

Said drive shaft 7 has a tubular body 13 forming an inner drive shaft chamber 14.

Said drive shaft 7 is directly and operatively connected to a harmonic transmission 10, also referred to as a strain wave gearing.

Said harmonic transmission 10 is directly and operatively connected to a rotary-to-linear motion conversion device 12 adapted to transform a rotary motion into a linear motion.

Said rotary-to-linear motion conversion device 12 is adapted to bias said at least one brake pad 3 to abut against said braking surface 4 along an axial direction A-A.

Said rotary-to-linear motion conversion device 12 is accommodated at least partially inside said inner drive shaft chamber 14.

According to an embodiment, said device comprises a rotational wave generator 9, referred to as a wave generator.

Said device further comprises a harmonic reducer 11 of said harmonic transmission 10.

Said harmonic reducer 11 is elastically deformed and rotated by said rotational wave generator 9. Said rotational wave generator 9 is at least partially made in one piece with said rotating drive shaft 7.

According to a general embodiment, a linear actuating device 1 for a brake caliper 2 adapted to bias at least one brake pad 3 to abut against a braking surface 4 of a brake disc 5, also referred to as a cartridge, is described below.

Said device 1 comprises a motor 6 comprising a rotating drive shaft 7 and a stator 8.

Said drive shaft 7 is directly and operatively connected to a harmonic transmission 10, referred to as a strain wave gearing.

Said harmonic transmission 10 is directly and operatively connected to a rotary-to-linear motion conversion device 12 adapted to transform a rotary motion into a linear motion.

Said linear actuating device 1 comprises a cover housing 36.

Said cover housing 36 accommodates in a self-supporting manner:
said motor 6; and
said harmonic transmission 10; and
said rotary-to-linear motion conversion device 12,
said rotary-to-linear motion conversion device 12 being left free to bias said at least one brake pad 3 to abut against said braking surface 4 along an axial direction A-A.

According to an embodiment, said cover housing 36 fits into a caliper body seat 39 provided in a caliper body 50 by entirely fitting it from the outside of the caliper body 50. For example, said caliper body seat 39 comprises an inner cartridge connection threading 58 and said cover housing 36 externally comprises an outer cartridge connection counter-threading 59 of linear actuating device, and said cover housing 36 is screwed by means of said threadings 58, 59.

According to an embodiment, said cover housing 36 is a single piece, i.e., in one piece.

According to an embodiment, said harmonic transmission 10 comprises a harmonic reducer 11, and said harmonic reducer 11 comprises a flexible cup 22 and a static ring 26.

Said static ring 26 is keyed onto and supported by said cover housing 36.

According to an embodiment, said cover housing 36 comprises a removable fastener 48 for removably fixing the linear actuating device 1 to a caliper body seat 39.

According to an embodiment, said cover housing 36 comprises a threading 48 for removably fixing the linear actuating device 1 to a caliper body seat 39 having a seat counter-threading 49.

According to an embodiment, said motor 6 is an electric motor.

According to an embodiment, said motor 6 is a brushless electric motor, e.g., known as BLDC.

According to an embodiment, said motor 6 is a brushless electric motor, and said rotating drive shaft 7 comprises permanent magnets 15.

According to an embodiment, said motor 6 is a brushless electric motor, and said rotating drive shaft 7 comprises permanent magnets 15 comprising plastoneodymium.

Said motor 6 is a brushless electric motor, and said rotating drive shaft 7 comprises permanent magnets 15 embedded in the body of said rotating drive shaft 7.

According to an embodiment, said rotational wave generator 9 is an elliptical bearing 21.

According to an embodiment, said rotating drive shaft 7 comprises at least one drive shaft bearing seat 17; said drive shaft bearing seat 17 is concentric to a rotation axis of said motor M-M parallel to the axial direction A-A.

Said rotating drive shaft 7 forms an elliptical bearing slewing ring 18 in one piece, which forms an elliptical rolling track.

Elliptical bearing rolling elements 19 and an outer elliptical bearing slewing ring 20 are associated with said elliptical bearing slewing ring 18, forming an elliptical bearing 21.

According to an embodiment, said harmonic transmission 10 comprises a harmonic reducer 11.

Said harmonic reducer 11 comprises a flexible cup 22 and a static ring 26.

Said flexible cup 22 comprises a flexible portion 24 of flexible cup, referred to as a flex spline, onto which a part of an elliptical bearing 21 elastically deforming it is keyed.

Said flexible portion 24 of flexible cup comprises, on the opposite side, cup teeth 25.

Said harmonic reducer 11 comprises a circular static ring 26.

Said static ring 26 comprises ring teeth 27.

Said cup teeth 25, where said deformed flexible cup 22 has the largest diameter, mesh with said ring teeth 27.

Said cup teeth 25 are fewer in number than said ring teeth 27 so that when said flexible portion 24 of flexible cup is deformed, the cup teeth 25 mesh with said ring teeth 27 in at least two points, e.g., the cup teeth 25 mesh with said ring teeth 27 at the opposite ends of the same meshing diameter.

Said linear actuating device 1 comprises a cover housing 36.

Said static ring 26 is fixedly keyed to the caliper body of said brake caliper 2. According to a different embodiment, said static ring 26 is fixedly keyed to said cover housing 36.

According to an embodiment, said harmonic transmission 10 comprises a harmonic reducer 11, and said harmonic reducer 11 comprises a flexible cup 22 and a static ring 26 mutually meshing in at least two points.

Said flexible cup 22 comprises a cup connection portion 28 to be keyed to said rotary-to-linear motion conversion device 12.

According to an embodiment, said harmonic transmission 10 comprises a harmonic reducer 11.

Said harmonic reducer 11 comprises a flexible cup 22 and a static ring 26 mutually meshing in at least two points, e.g., two teeth.

Said flexible cup 22 comprises a cup connection portion 28 formed by a tubular sleeve.

Said cup connection portion 28 formed by a tubular sleeve is keyed to a screw nut 281.

Said screw nut 281 is supported freely to rotate and axially constrained to avoid a movement thereof along the axial direction A-A.

Said screw nut 281 meshes with a worm screw 29 which translates along said axial direction A-A upon the rotation of the screw nut 281.

According to an embodiment, said flexible cup 22 comprises a cup connection portion 28.

Said cup connection portion 28 is connected to the rotary-to-linear motion conversion device 12, and said cup connection portion 28 is arranged mainly inside said inner drive shaft chamber 14.

Said rotary-to-linear motion conversion device 12 comprises a screw nut 281 which accommodates a worm screw 29.

Said worm screw 29 meshes in said screw nut 281 and converts the rotary motion of the screw nut 281 into the linear motion of the worm screw 29.

According to an embodiment, said rotary-to-linear motion conversion device 12 comprises a screw nut 281 which accommodates a recirculating ball worm screw 29.

Said worm screw 29 meshes in said screw nut 281 and converts the rotary motion of the screw nut 281 into the linear motion of the worm screw 29.

According to an embodiment, said rotary-to-linear motion conversion device 12, when in the retracted position, is substantially completely accommodated in said inner drive shaft chamber 14, e.g., except for a pushing plate adapted to rest on a brake pad, which projects outward to interact with said brake pad.

According to an embodiment, said flexible cup 22 comprises a cup connection portion 28; said cup connection portion 28 is connected to a first plate 30.

According to an embodiment, said first plate 30 comprises ramp tracks 31 extending circumferentially along a circumferential direction about said axial direction A-A and gradually extend in the axial direction A-A.

Said first plate 30 is translationally constrained along said axial direction A-A to avoid an axial movement thereof and free to rotate about said axial direction A-A.

Said ramp tracks 31 accommodate plate rolling elements 32, e.g., balls or rollers.

Said first plate 30 faces a second plate 33.

Said second plate 33 comprises second plate seats 34 which accommodate said plate rolling elements 32, where said second plate seats 34 face said ramp tracks 31.

Said first plate 30 or said second plate 33 is translationally constrained along said axial direction A-A to avoid an axial movement thereof and free to rotate about said axial direction A-A.

Said second plate 33 or said first plate 30 is rotationally constrained and free to move in the axial direction A-A so that upon a rotation of the first or second plate 30 or 33, the rolling elements 32 roll while remaining in their seats of the second plate 34 but rise along said ramp tracks 31 moving the second plate 33 or said first plate 30 axially.

According to an embodiment, said screw nut 281 or first or second plate 30, 33 of said rotary-to-linear motion conversion device 12 rests against an axial thrust bearing 35 which counteracts the displacement of this component in the axial direction A-A:

According to an embodiment, said rotary-to-linear motion conversion device 12 is connected to a wear recovery device 47 of the at least one pad 3.

According to an embodiment, said screw nut 281 or first or second plate 30, 33 of said rotary-to-linear motion conversion device 12 rests against an axial thrust bearing 35 which counteracts the displacement of this component in the axial direction A-A; and said axial thrust bearing 35 rests, directly or indirectly, against a wear recovery device 47 of the at least one pad 3.

According to an embodiment, said thrust bearing 35 rests either directly or indirectly against a force sensor 46.

According to an embodiment, said wear recovery device 47 of the at least one pad 3 rests on a force sensor 46.

According to an embodiment, said linear actuating device 1 comprises a cover housing 36 which accommodates and supports the stator 8 of the motor 6.

According to an embodiment, said linear actuating device 1 comprises a cover housing 36 which supports and accommodates a motor sleeve 37 which keyedly supports a radial motor roller bearing 38 which supports said rotating drive shaft 7 of the motor 6.

According to an embodiment, said linear actuating device 1 comprises a cover housing 36 which supports a static ring 26 of the harmonic transmission 10.

Said cover housing 36 forms a cartridge being assemblable and disassemblable to/from a caliper body seat 39 provided in said brake caliper 2 while maintaining at least the motor components 6, the harmonic transmission 10, and the rotary-to-linear motion conversion device 12 accommodated inside said cover housing 36.

According to an embodiment, said rotary-to-linear motion conversion device 12 is jointedly connected to a pushing plate 40 adapted to rest on said at least one brake pad 3.

The present invention also relates to a brake caliper 2 comprising at least one linear actuating device 1 according to any one of the embodiments described above; where the brake caliper has one of the following features:
said brake caliper 2 is a floating brake caliper;
said brake caliper 2 is a fixed brake caliper and said linear actuating device 1 consists of at least two opposing linear actuating devices 1.

In order to meet specific, contingent needs, those skilled in the art may make several changes and adaptations to the above-described embodiments and may replace elements with others which are functionally equivalent, without however departing from the scope of he following claims.

According to a general embodiment, a caliper body 50 of brake caliper comprises at least one component shaped as a closed-ring yoke.

Said component 51 is yoke-shaped and has an outer component side 52 and an opposite inner component side 53 adapted to face a brake disc 5.

Said component 51 comprises at least one caliper body seat 39.

Said caliper body seat 39 is a through seat from the outer component side 52 to the inner component side 53.

Said caliper body seat 39 removably accommodates a linear actuating device 1.

Said linear actuating device 1 is accommodated in said caliper body seat 39 so as to pass through said component 51 and be adapted to interact with a brake pad 3 to apply a braking action to said brake disc 5.

According to an embodiment, said component 51 is a floating caliper body 41.

According to an embodiment, said component 51 is a fixed caliper body comprising at least two opposing caliper body seats 39.

According to an embodiment, said at least one caliper body seat 39 comprises an outer seat skirt 54.

Said outer seat skirt 54 is cylindrical in shape.

At least one axial extension segment X-X of said outer seat skirt 54 is entirely free except for two component ribs 55, 56 spaced apart from said outer seat skirt 54. According to an embodiment, where said at least one caliper body seat 39 is made on the opposite side of the caliper body, at least one axial extension segment X-X of said outer seat skirt 54 is entirely free except for two component ribs 55 spaced apart from said outer housing skirt 54.

According to an embodiment, said at least one caliper body seat 39 comprises an outer seat skirt 54.

Said outer seat skirt 54 is cylindrical in shape.

At least one axial extension segment X-X of said outer seat skirt 54 is entirely free except for two component ribs 56 spaced apart from said outer seat skirt 54 forming an angle of about 160 DEG therebetween.

According to an embodiment, said at least one caliper body seat 39 comprises an outer seat skirt 54.

Said outer seat skirt 54 is cylindrical in shape.

At least one axial extension segment X-X of said outer seat skirt 54 is entirely free except for two component ribs 56 spaced apart from said outer seat skirt 54 forming said yoke-shaped component 51.

According to an embodiment, said at least one caliper body seat 39 comprises an outer seat skirt 54.

Said outer seat skirt 54 is cylindrical in shape.

At least one axial extension segment X-X of said outer seat skirt 54 is entirely free except for two component ribs 56 spaced apart from said outer seat skirt 54.

Said cylindrical outer seat skirt 54 defines an outer cylindrical surface 57 which protrudes above said two component ribs 56 in the outer radial direction RE over an arc of more than 180 DEG of the cross-section thereof in a circumferential C-C and radial R-R plane.

According to an embodiment, said at least one caliper body seat 39 comprises an inner cartridge connection threading 58 for removably connecting said linear actuating device 1 provided with an outer cartridge connection counter-threading 59.

According to an embodiment, said at least one caliper body seat 39 comprises an axial annular abutment 60 which projects towards the inside of said at least one caliper body seat 39 to abut against said linear actuating device 1.

According to an embodiment, said yoke-shaped component 51 comprises a vehicle-side elongated element 61, adapted to face said brake disc 5 on the side thereof facing a vehicle; and a wheel-side elongated element 62, adapted to face said brake disc 5 on the side thereof facing a wheel of the vehicle.

Said yoke-shaped component 51 comprises at least one component rib 55, 56 which extends peripherally along the extension of said vehicle-side elongated element 61 and wheel-side elongated element 62, interrupted by said at least one caliper body seat 39.

According to an embodiment, said yoke-shaped component 51 comprises a vehicle-side elongated element 61, adapted to face said brake disc 5 on the side thereof facing a vehicle; and a wheel-side elongated element 62, adapted to face said brake disc 5 on the side thereof facing a wheel of the vehicle.

Said yoke-shaped component 51 comprises at least one component rib 55, 56 which extends peripherally along the extension of said vehicle-side elongated element 61 and wheel-side elongated element 62.

The radial height R-R of said at least one component rib 55, 56 is less than the overall radial height R-R of said yoke-shaped component 51, except for the body portion delimiting said caliper body seat 39.

According to an embodiment, said component 51 is a floating caliper body 41.

Said floating caliper body comprises sliding guide seats 63, 64 adapted to accommodate sliding pins 65, 66 connected to a floating brake caliper bracket 42 adapted to connect to a vehicle.

Said sliding guide seats 63, 64 protrude in the outer radial direction RE from said floating caliper body 41.

According to an embodiment, said yoke-shaped component 51 comprises a vehicle-side elongated element 61, adapted to face said brake disc 5 on the side thereof facing a vehicle; and a wheel-side elongated element 62, adapted to face said brake disc 5 on the side thereof facing a wheel of the vehicle.

Said vehicle-side elongated element 61 and wheel-side elongated element 62 are at least connected to each other by two end bridges 67, 68.

Each of said vehicle-side elongated element 61 and wheel-side elongated element 62 comprises an inner component side or inner floating body side 53.

Said inner component side or inner floating body side 53 comprises two ridges 69, 70 which project inwards to form pad abutting shoulders 71, 72 forming a pad seat 73 therebetween.

According to an embodiment, said yoke-shaped component 51 comprises a vehicle-side elongated element 61, adapted to face said brake disc 5 on the side thereof facing a vehicle; and a wheel-side elongated element 62, adapted to face said brake disc 5 on the side thereof facing a wheel of the vehicle.

Said vehicle-side elongated element 61 and wheel-side elongated element 62 are at least connected to each other by two end bridges 67, 68.

Each of said vehicle-side elongated element 61 and wheel-side elongated element 62 comprises an inner component side or inner floating body side 53.

Said inner component side or inner floating body side 53 comprises two ridges 69, 70 which project inwards to form pad abutting shoulders 71, 72 forming a pad seat 73 therebetween.

Said pad abutting shoulders 71, 72 converge approaching each other as they extend in the inner radial direction RI.

The present invention also relates to a brake caliper 2 comprising a caliper body 50 according to any one of the embodiments described above.

According to an embodiment, a linear actuating device 1 made according to any one of the embodiments described above is removably accommodated in said at least one caliper body seat 39.

### LIST OF REFERENCE SIGNS

1 linear actuating device
2 brake caliper
3 brake pad
4 braking surface
5 brake disc
6 motor
7 rotating drive shaft
8 stator
9 rotational wave generator
10 harmonic transmission or strain wave gearing
11 harmonic reducer
12 rotary-to-linear motion conversion device
13 tubular body of drive shaft
14 inner chamber of drive shaft
15 permanent magnets of drive shaft
16 first portion of drive shaft
17 bearing seat of drive shaft
18 slewing ring of elliptical bearing
19 rolling elements of elliptical bearing
20 outer slewing ring of elliptical bearing
21 elliptical bearing
22 flexible cup
24 flexible portion of flexible cup
25 cup teeth
26 static ring
27 ring teeth
28 cup connection portion
281 screw nut
29 worm screw or recirculating ball worm screw
30 first plate
31 ramp tracks
32 rolling elements of plate
33 second plate
34 second plate seats
35 axial thrust bearing
36 cover housing
37 motor sleeve
38 radial motor bearing
39 caliper body seat
40 pushing plate adapted to rest on a brake pad
41 floating body of floating brake caliper
42 floating brake caliper bracket
43 elastic device for moving the pads away from the brake disc
44 brake disc bell
45 dust seal
46 force sensor
47 wear recovery device
48 caliper connection threading of the cover housing
49 counter-threading of caliper body seat
50 caliper body
51 floating body or yoke-shaped component
52 outer component side or outer floating body side
53 inner component side or inner floating body side
54 outer seat skirt
55 component rib
56 component rib
57 outer cylindrical surface
58 inner cartridge connection threading
59 outer cartridge connection counter-threading of linear actuating device
60 axial annular abutment of caliper body seat
61 vehicle-side elongated element
62 wheel-side elongated element
63 sliding guides
64 sliding guides
65 sliding pins
66 sliding pins
67 end bridge
68 end bridge
69 ridge
70 ridge
71 pad abutting shoulder
72 pad abutting shoulder
73 pad seat
X-X rotation axis
A-A axial direction
R-R radial direction
C-C circumferential direction
M-M motor axis
RE outer radial direction
RI inner radial direction

1-18. (canceled)

19. A linear actuating device for a brake caliper adapted to bias at least one brake pad to abut against a braking surface of a brake disc, wherein said linear actuating device comprises:
a motor comprising a rotating drive shaft and a stator;
a harmonic transmission comprising:
a rotational wave generator of a strain wave gearing of said harmonic transmission, wherein
said rotational wave generator is at least partially made in one piece with said rotating drive shaft; and
a harmonic reducer, wherein
said harmonic reducer is elastically deformed and rotated by said rotational wave generator; and
a rotary-to-linear motion conversion device adapted to transform a rotary motion into a linear motion adapted to bias said at least one brake pad to abut against said braking surface along an axial direction, said rotary-to-linear motion conversion device being rotatably connected to said harmonic reducer.

20. The linear actuating device of claim 19, wherein
said harmonic transmission is superimposed on said rotary-to-linear motion conversion device;
or wherein
said rotary-to-linear motion conversion device comprises a screw nut which meshes with a worm screw that translates along the axial direction upon a rotation of the screw nut, and wherein said harmonic transmission is superimposed on said screw nut.

21. The linear actuating device of claim 19, wherein
said rotating drive shaft comprises a tubular body forming an inner drive shaft chamber, and wherein
said rotary-to-linear motion conversion device, in a retracted position, is at least partially accommodated inside said inner drive shaft chamber.

22. The linear actuating device of claim 21, wherein
said rotary-to-linear motion conversion device is accommodated radially, with respect to an axis of said tubular body, inside said tubular body of the rotating drive shaft; and/or wherein
said rotary-to-linear motion conversion device, in the retracted position, is completely accommodated inside said inner drive shaft chamber except for a pushing plate, adapted to rest on the at least one brake pad, which projects outward to interact with said at least one brake pad.

23. The linear actuating device of claim 19, wherein the linear actuating device comprises one of the following features or a combination thereof:
said motor is an electric motor;
said motor is a brushless electric motor;
said motor is a brushless electric motor and said rotating drive shaft comprises permanent magnets;
said motor is a brushless electric motor and said rotating drive shaft comprises permanent magnets comprising plastoneodymium;
said motor is a brushless electric motor and said rotating drive shaft comprises permanent magnets embedded in said rotating drive shaft.

24. The linear actuating device of claim 19, wherein
said rotational wave generator is an elliptical bearing; and/or wherein
said rotating drive shaft comprises at least one drive shaft bearing seat, wherein said drive shaft bearing seat is concentric to a rotation axis of said motor parallel to the axial direction, wherein said rotating drive shaft forms in one piece an elliptical bearing slewing ring which forms an elliptical track, and wherein elliptical bearing rolling elements and an outer elliptical bearing slewing ring are associated with said elliptical bearing slewing ring, forming an elliptical bearing.

25. The linear actuating device of claim 19, wherein said harmonic reducer comprises a flexible cup and a static ring, wherein said flexible cup comprises a flexible portion of flexible cup, to which an elliptical bearing, which deforms it elastically, is keyed onto one side, wherein said flexible portion of flexible cup comprises cup teeth on an opposite side, wherein said static ring comprises ring teeth, wherein said cup teeth mesh with said ring teeth where said deformed flexible cup has a largest diameter, wherein said cup teeth are fewer in number than said ring teeth so that when said flexible portion of flexible cup is deformed, the cup teeth mesh, in at least two points, with said ring teeth, optionally the cup teeth meshing with said ring teeth at opposite ends of a same meshing diameter, wherein said linear actuating device further comprises a cover housing, and wherein said static ring is fixedly keyed to a caliper body of said brake caliper or said static ring is fixedly keyed to said cover housing.

26. The linear actuating device of claim 19, wherein said harmonic reducer comprises a flexible cup and a static ring meshing each other in at least two points, and wherein said flexible cup comprises a cup connection portion to be keyed to said rotary-to-linear motion conversion device.

27. The linear actuating device of claim 19, wherein said harmonic reducer comprises a flexible cup and a static ring meshing each other in at least two points, wherein said flexible cup comprises a cup connection portion formed by a tubular sleeve, wherein said cup connection portion formed by the tubular sleeve is keyed to a screw nut, wherein said screw nut is supported to be free to rotate and axially constrained to avoid a movement thereof along the axial direction, and wherein said screw nut meshes with a worm screw that translates along said axial direction upon a rotation of the screw nut.

28. The linear actuating device of claim 21, wherein said harmonic reducer comprises a flexible cup and a static ring mutually meshing in at least two points, wherein said flexible cup comprises a cup connection portion, wherein said cup connection portion is connected to the rotary-to-linear motion conversion device and arranged mainly inside said inner drive shaft chamber, wherein said rotary-to-linear motion conversion device comprises a screw nut that accommodates a worm screw, and wherein said worm screw meshes in said screw nut and converts a rotary motion of the screw nut into a linear motion of the worm screw.

29. The linear actuating device of claim 19, wherein said rotary-to-linear motion conversion device comprises a screw nut that accommodates a worm screw, and wherein said worm screw meshes in said screw nut and converts a rotary motion of the screw nut into a linear motion of the worm screw.

30. The linear actuating device of claim 21, wherein said rotary-to-linear motion conversion device, in the retracted position, is substantially completely accommodated in said inner drive shaft chamber.

31. The linear actuating device of claim 19, wherein
said harmonic reducer comprises a flexible cup and a static ring mutually meshing in at least two points, wherein
said flexible cup comprises a cup connection portion connected to a first plate, wherein
said first plate comprises ramp tracks that extend circumferentially about said axial direction and gradually extend in the axial direction, wherein
said first plate is translationally constrained along said axial direction to avoid an axial movement thereof and free to rotate about said axial direction, wherein
said ramp tracks accommodate plate rolling elements, the plate rolling elements optionally being balls or rollers, and wherein
said first plate faces a second plate, and said second plate comprises second plate seats that accommodate said plate rolling elements and face said ramp tracks.

32. The linear actuating device of claim 31, wherein
said first plate or said second plate is translationally constrained along said axial direction to avoid an axial movement thereof and free to rotate about said axial direction, and wherein
said second plate or said first plate is rotationally constrained and free to move in the axial direction so that upon a rotation of the first or second plate, the plate rolling elements roll while remaining in the second plate seats of the second plate but rise along said ramp tracks axially moving the second plate or the first plate.

33. The linear actuating device of claim 19, wherein
said rotary-to-linear motion conversion device comprises a screw nut that accommodates a worm screw or a first plate and a second plate, at least one of the first and second plates comprising ramp tracks that accommodate plate rolling elements; and wherein
said screw nut or said first or second plate of said rotary-to-linear motion conversion device rests against an axial thrust bearing which counteracts a displacement thereof in the axial direction; and wherein the linear actuating device comprises at least one of the following features:
said rotary-to-linear motion conversion device is connected to a wear recovery device of the at least one brake pad;
said rotary-to-linear motion conversion device comprises a screw nut that accommodates a worm screw or a first plate and a second plate, at least one of the first and second plates comprising ramp tracks that accommodate plate rolling elements; and wherein said screw nut or said first or second plate of said rotary-to-linear motion conversion device rests against an axial thrust bearing which counteracts a displacement thereof in the axial direction, and said axial thrust bearing rests, directly or indirectly, against a wear recovery device of the at least one brake pad.

34. The linear actuating device of claim 19, wherein the linear actuating device comprises one of the following features or a combination thereof:
said linear actuating device comprises a cover housing that accommodates and supports the stator of the motor;
said linear actuating device comprises a cover housing that supports and accommodates a motor sleeve which keyedly supports a radial motor bearing supporting said rotating drive shaft;
said linear actuating device comprises a cover housing supporting a static ring of the harmonic transmission, wherein said cover housing forms a cartridge assemblable and disassemblable to/from a caliper body seat provided in said brake caliper while maintaining at least the motor, the harmonic transmission and the rotary-to-linear motion conversion device accommodated inside said cover housing;
said rotary-to-linear motion conversion device is jointedly connected to a pushing plate adapted to rest on said at least one brake pad.

35. A brake caliper comprising at least one linear actuating device according to claim 19, wherein the brake caliper comprises one of the following features:
the brake caliper is a floating brake caliper;
the brake caliper is a fixed brake caliper and said linear actuating device consists of at least two opposing linear actuating devices.

36. A disc brake comprising the brake caliper of claim 35 arranged straddling a brake disc.
